(19) United States
(12) Patent Application Publication
(10) Pub. No.: US 2026/0218876 A1
(43) Pub. Date: Jul. 30, 2026

(54) VEHICLE LIGHT SYSTEM WITH WORKLIGHT FEATURE AND METHOD OF USE THEREOF

(71) Applicant: YourTruckShop Inc., Laval (CA)

(72) Inventors: David Merovitz, Cote Saint Luc (CA); Mitchell Robert Magonet, Cote Saint Luc (CA); Guocheng WEN, Laval (CA); Jingkai ZHOU, Laval (CA)

(21) Appl. No.: 19/036,167

(22) Filed: Jan. 24, 2025

(51) Int. Cl. F21S 43/00; F21S 43/14; F21S 43/19; F21S 45/48; F21W 103/20; F21W 103/35; F21W 103/45; F21W 131/10; F21Y 113/13; F21Y 115/10

(52) U.S. Cl. CPC F21S 43/601; F21S 43/14; F21S 43/195; F21S 45/48; F21W 2103/20; F21W 2103/35; F21W 2103/45; F21W 2131/1005; F21Y 2113/13; F21Y 2115/10

(57) ABSTRACT

A lighting device; it has a housing; and an LED lighting system defining a surface with a first section and a second section and having a first LED array corresponding to the first section and a second LED array corresponding to the second section; an input interface adapted to receive inputs to selectively cause the first LED array to generate the light at a lower luminosity level or an upper luminosity level corresponding to a state of the vehicle and the second LED array to generate the light at a lower luminosity level corresponding to a state of the vehicle or an upper luminosity level to function as a work lamp; a method of use thereof.

### TECHNICAL FIELD

The present disclosure relates to vehicle accessories, and more particularly to vehicle lighting accessories.

### BACKGROUND

After-market lights and lighting accessories for use with vehicles using public roads are often required to meet certain regulatory requirements for public road use, thereby imposing limitations on their configuration, such as their dimensions, size, colour, brightness, etc. As such, these limitations can restrict certain functionalities that may be offered by these lights and lighting accessories.

It would be advantageous to develop certain lighting devices for use with vehicles that can offer additional functionalities for vehicle operators while still meeting regulatory requirements for public road use.

### SUMMARY OF INVENTION

The present disclosure relates to lighting devices to provide requisite signaling to the drivers of other vehicles by meeting certain regulations for road use with respect to vehicle lights and requisite signaling while also having the ability to function as work light or provide other lighting functionality.

The lighting device defines a lighting surface with two sections, a first section and a second section. The second section occupies a portion of the lighting surface and comprises a concentrated area on the lighting surface and can be actuated, following receipt of an input, to function at two different luminosity levels: at a lower luminosity level to signal a state of the vehicle (e.g. a reverse light when the vehicle is reversing) and then at an upper luminosity level that is greater than the lower luminosity level, as a work light (e.g. for permitting an operator to work adjacent to the lighting device under low light conditions (for example at night)) or other lighting functionality. In turn, the first section, taking up the rest of the lighting surface, has dimensions that may be sufficiently large to meet regulatory requirements for providing adequate signaling when the vehicle is in certain states (e.g. an operating state, a moving state, a braking state, a turning state, a reversing state, etc.) corresponding to actions taken by the driver of the vehicle.

One aspect provides a lighting device adapted for fastening to a vehicle, comprising a housing; an LED lighting system contained at least partially within the housing defining a lighting surface for generating light, wherein the lighting surface includes a first section and a second section in a concentrated area adjacent to the first section, the LED lighting system comprising: a first LED array adapted to emit light from the first section; and a second LED array adapted to emit light from the second section at a lower luminosity level and an upper luminosity level, wherein the upper luminosity level is greater than the lower luminosity level; and an input interface adapted to receive inputs to selectivity cause: an emission of light from the first LED array to signal a first state of the vehicle; an emission of light at the lower luminosity level from the second LED array to signal a second state of the vehicle; and an emission of light at the upper luminosity level from the second LED array.

In some embodiments, the lighting device may further comprise a heat sink adapted to dissipate heat generated by at least the second LED array, including embodiments wherein the heat sink may be positioned on a back surface of the housing.

In other embodiments, the first state of the vehicle may be any one of an operating state, a moving state, a braking state, a turning state, and a reversing state; and the second state of the vehicle may be any one of an operating state, a moving state, a braking state, a turning state, and a reversing state that is different from the first state; and the upper luminosity level of the second LED array may be to provide a work lamp function. For example, the upper luminosity level of the second LED array may be equal to or greater than 800 lumens.

In further embodiments, the first LED array may be adapted to emit light at a lower luminosity level and an upper luminosity level, wherein the upper luminosity level is greater than the lower luminosity level; and the input interface may be adapted to receive inputs to selectively cause an emission of light at the lower luminosity level from the first LED array to signal the first state of the vehicle; an emission of light at the upper luminosity level from the first LED array to signal a third state of the vehicle. In some embodiments, the first state of the vehicle may be an operating state or a moving state; and the third state of the vehicle may be either a braking state or a turning state. In other embodiments, the third state of the vehicle may be a turning state; and light may be emitted at the upper luminosity level from the first LED array intermittently.

In another aspect, the light emitted from the first section may be a first colour and the light emitted from the second section may be a second colour different from the first colour. In some aspects, the first colour may be red and the second colour may be white.

In yet further embodiments, the lighting device further comprising a controller that may be configured to receive the inputs to selectively cause an emission of light from the first LED array to signal the first state of the vehicle; an emission of light at the lower luminosity level from the second LED array to signal the second state of the vehicle; and an emission of light at the upper luminosity level from the second LED array. In some embodiments, the controller that is configured to receive the inputs to selectively cause an emission of light at the lower luminosity level from the first LED array to signal the first state of the vehicle; an emission of light at the upper luminosity level from the first LED array to signal the third state of the vehicle; an emission of light at the lower luminosity level from the second LED array to signal the second state of the vehicle; and an emission of light at the upper luminosity level from the second LED array. In one aspect, the controller may comprise an electrical circuit. In another aspect, the controller may comprise a microprocessor.

In other aspects, the second section of the LED lighting system may be defined between a portion of an edge of the lighting surface and a boundary line that runs from a first point of the edge to a second point of the edge, the boundary line separating the first section of LED lighting system from the second section of LED lighting system.

In some aspects, the input interface may receive power from the vehicle for powering the LED lighting system; In other aspects, the lighting device may further comprise a battery for supplying power to the LED lighting system.

In yet further embodiments, the lighting device may be fastened to a rear of the vehicle. In some aspects, the vehicle may be a truck and the lighting device may be adapted to be fastened to a rear of the truck. In other aspects, the vehicle may be a trailer and the lighting device may be adapted to be fastened to a rear of the trailer.

### BRIEF DESCRIPTION OF THE DRAWINGS

The invention will be better understood by way of the following detailed description of embodiments of the invention with reference to the appended drawings, in which:

FIG. 1A is a front view of an exemplary lighting device in accordance with the present teachings;

FIG. 1B is a left-side view of the exemplary lighting device of FIG. 1A;

FIG. 1C is a right-side view of the exemplary lighting device of FIG. 1A;

FIG. 1D is a top-down view of the exemplary lighting device of FIG. 1A;

FIG. 1E is a bottom view of the exemplary lighting device of FIG. 1A;

FIG. 1F is an exploded back perspective view of the exemplary lighting device of FIG. 1A;

FIG. 1G is a back view of the exemplary lighting device of FIG. 1A;

FIG. 1H is a front perspective view of the exemplary lighting device of FIG. 1A with the lens removed;

FIG. 2A is a front view of an exemplary lighting device in accordance with the present teachings;

FIG. 2B is a back view of the exemplary lighting device of FIG. 2A;

FIG. 2C is a right-side view of the exemplary lighting device of FIG. 2A;

FIG. 2D is a left-side view of the exemplary lighting device of FIG. 2A;

FIG. 2E is a top-down view of the exemplary lighting device of FIG. 2A;

FIG. 2F is a bottom view of the exemplary lighting device of FIG. 2A;

FIG. 2G is an exploded perspective view of the exemplary lighting device of FIG. 2A;

FIG. 2H is a front perspective view of the exemplary lighting device of FIG. 2A with the lens removed;

FIG. 3 is a block diagram of an exemplary lighting device in communication with an exemplary vehicle; and

FIG. 4 is a flowchart diagram of an exemplary method of operating a lighting device for signaling other vehicles and for functioning as a work light.

### DETAILED DESCRIPTION

The present disclosure relates to a lighting device that is adapted to be installed on a vehicle (e.g. a rear of the vehicle) and to provide dual functionality of acting as a signal for other drivers of vehicles sharing a road with the vehicle with the lighting device, and to operate as a work light or provide other functionality when needed.

The lighting device is connectable to the vehicle through an interface that permits the lighting device to receive input corresponding to states of the vehicle and other inputs that can trigger a configured lighting effect that is generated by the lighting device. Moreover, the position of the section of the lighting surface of the lighting device that provides the work light or other functionality is in a concentrated area on the lighting surface which may reduce the footprint taken by section of the lighting surface while emitting the required light distribution to operate as a work light or other functionality, thereby providing a greater remaining section of the lighting surface that is used to signal a state of the vehicle, this greater section having a size that may be sufficient to comply with regulatory requirements in given jurisdictions. The state of the vehicle may include an operating state (e.g. the vehicle is turned on or the light system of the vehicle is turned on), a moving state (e.g. the vehicle is in motion), a braking state (e.g. the brakes are applied), a turning state (e.g. the turn signal has been activated), a reversing state (e.g. the vehicle is put into reverse), etc. The work light portion of the lighting surface may also be used at a lower luminosity level to provide a dual functionality of signaling a state of the vehicle. For example, when the vehicle is placed into reverse, the section of the lighting surface that provides the work light or other functionality may also emit light at a luminosity level that is lower than a luminosity level of the light emitted when this section operates as a work light or other functionality.

Unless the context requires otherwise, throughout the specification and claims which follow, the word “comprise” and variations thereof, such as, “comprises” and “comprising” are to be construed in an open, inclusive sense, that is as “including, but not limited to”.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

From the foregoing it will be appreciated that, although specific embodiments have been described herein for purposes of illustration, various modifications may be made without deviating from the spirit and scope of the teachings. Accordingly, the claims are not limited by the disclosed embodiments.

### Definitions

In the present disclosure, “vehicle” includes a motor vehicle (e.g. gas-powered, electric-powered, etc.) which may be used for transportation on land (e.g. roads, off-roading). Vehicles include a trailer or other device that may be towed by a motor vehicle. Exemplary vehicles include, but are not limited to, cars, trucks, trailers, four-by-fours, etc.

### Exemplary Lightning Device

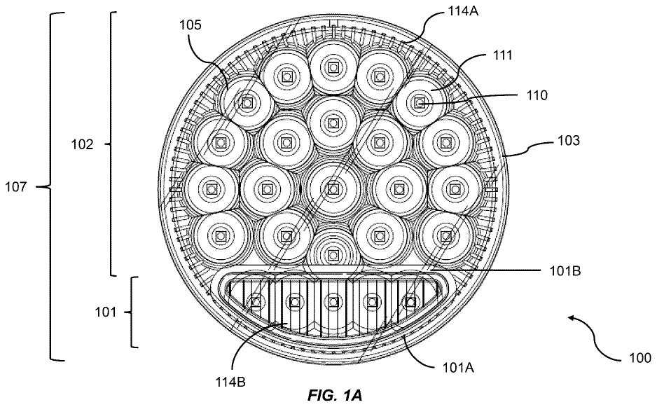

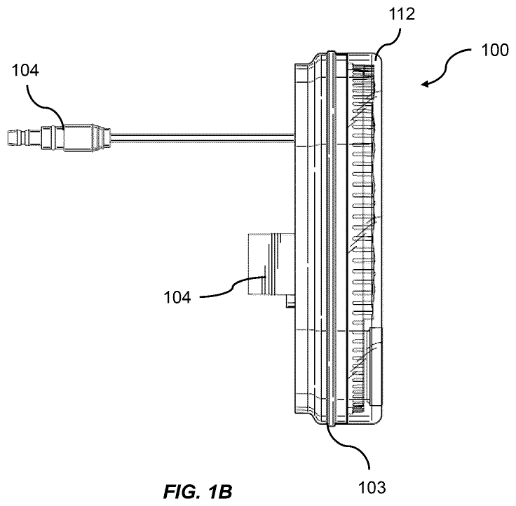

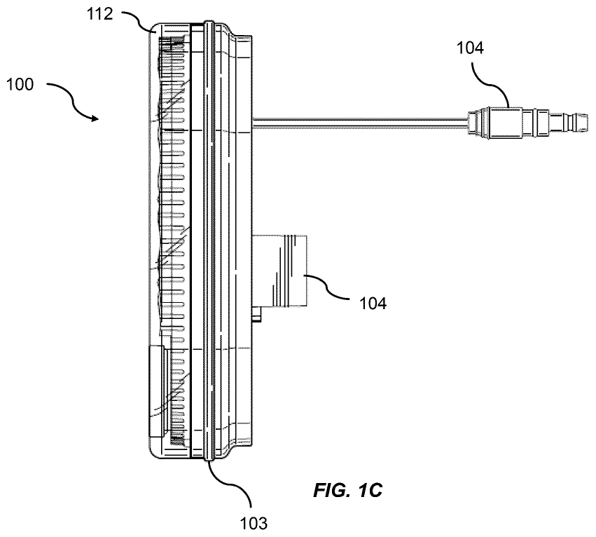

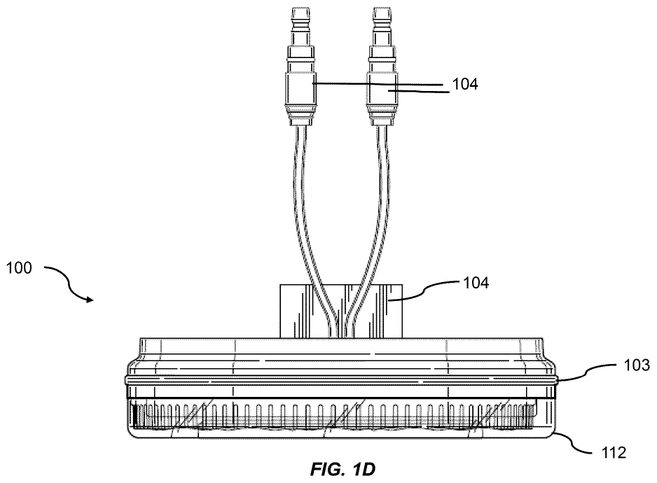

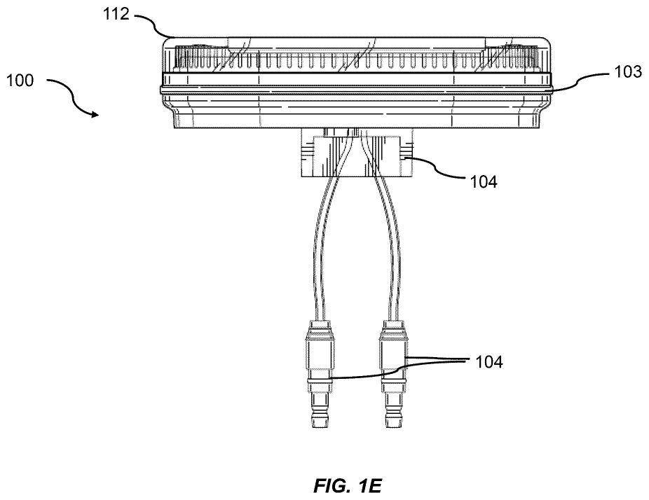

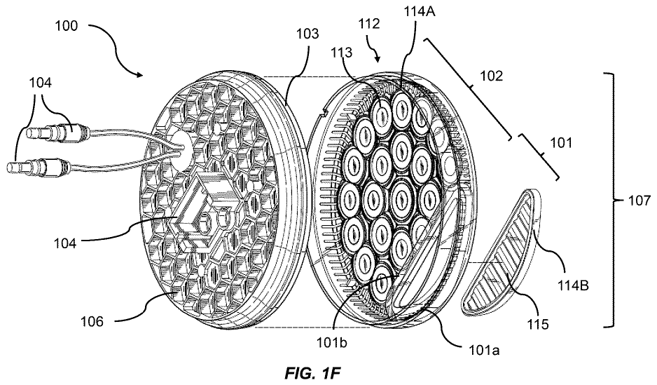

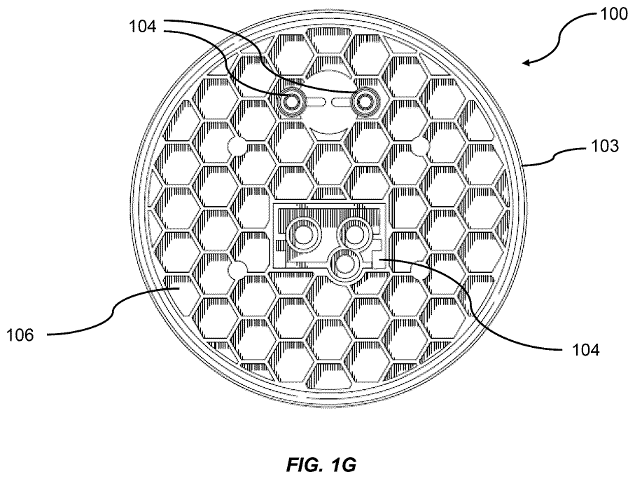

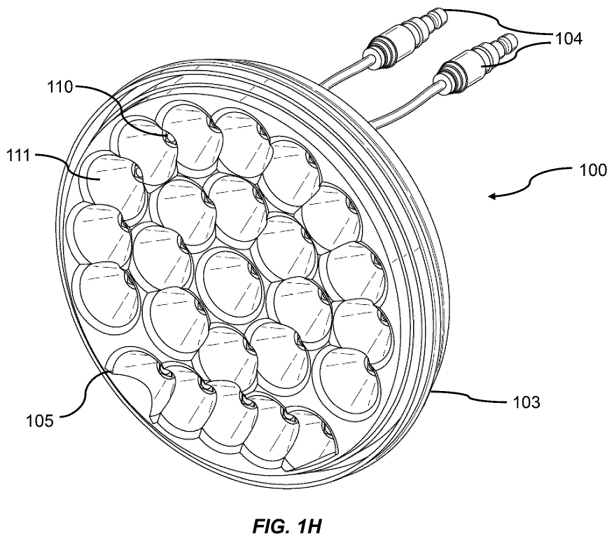

Reference is made to FIGS. 1A-1H an illustrating exemplary lighting device 100 in accordance with the present teachings.

The lighting device 100 includes a housing 103 and an LED lighting system 105 defining a lighting surface 107. The lighting surface 107 is divided into a first section 102 and a second section 101. The lighting device 100 includes an input interface 104 for connecting to a vehicle (in some instances, the input interface 104 may also be configured to output information, acting as an input/output (I/O) interface, or as a power source) or other input source.

The LED lighting system 105 comprises a plurality of LEDs 110 (an array of LEDs) arranged across the lighting surface 107. The LEDs may be spaced apart or alternatively, may be positioned adjacent to each other. The lighting device 100 may also include a heat sink 106.

In some embodiments, the LEDs 110 of the LED lighting system 105 corresponding to the first section 102 are configured to emit light at two distinct levels of luminosity namely a lower luminosity level and an upper luminosity level being greater than the lower luminosity level. Similarly, in some embodiments, the LEDs 110 of the LED lighting system 105 corresponding to the second section 101 are configured to emit light at two distinct levels of luminosity namely a lower luminosity level and an upper luminosity level being greater than the lower luminosity level. For example, the lower luminosity level may be 300 lumens, and the upper luminosity level may be 800 lumens or greater. It will be understood that the intensities at the lower luminosity level and/or the upper luminosity level for the first section 102 or the second section 101 may vary without departing from the present teachings, provided that the upper luminosity level is greater than the lower luminosity level. In other embodiments, the LEDs 110 of the LED lighting system 105 corresponding to the first section 102 and/or the second section 101 may include a first set and a second set of LEDs, being provided and configured to alternate when switching from producing light at the lower luminosity level and from producing light at the upper luminosity level (e.g. the first set of LEDs producing light at the lower luminosity level and the second set of LEDs producing light alone, or in combination with the first set of LEDs, at the upper luminosity level).

In some embodiments, some or all of the LEDs 110 of the LED lighting system 105 may be provided with a corresponding reflector 111 surrounding the LED to redirect the light of produced by the LED. The reflector 111 may have a conical or frustoconical shape, with the LED 110 positioned at the center of the conical or frustoconical shape. One or more sides of the reflector 111 may be truncated where a reflector 111 intersects with an adjacent reflector 111 of an adjacent LED 110, as illustrated in FIGS. 1A and 1H. It will be understood that the shape of the reflector 111 may vary without departing from the present teachings, where the shape of the reflector 111 influences the direction of light being emitted by the LED lighting system 105. In some instances, the design or specifications of each of the reflectors 111 of the LED lighting system 105 may be the same. In some instances, the design or specifications of some or all of the reflectors 111 of the LED lighting system 105 may be different from the design or specifications of the other reflectors 111 of the LED lighting system 105.

In some instances, the design or specifications of the reflectors 111 of the LEDs 110 corresponding to the first section 102 may be different from the design or specifications of the reflectors 111 of the LEDs 110 corresponding to the second section 101. In some instances, the design or specifications of the reflectors 111 of the LEDs 110 corresponding to the first section 102 may be the same as the design or specifications of the reflectors 111 of the LEDs 110 corresponding to the second section 101.

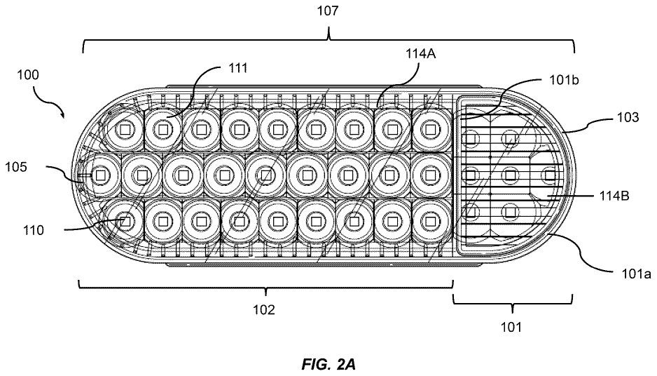

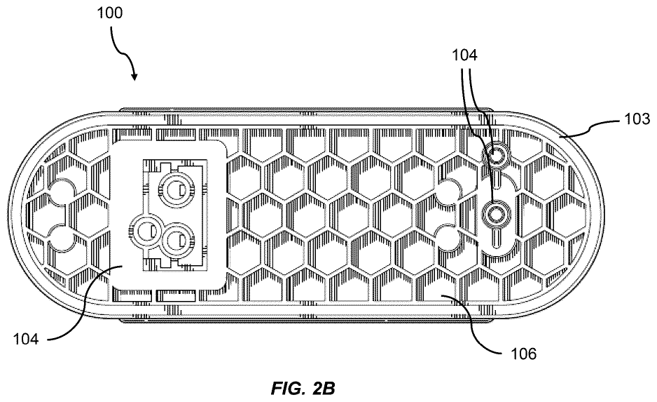

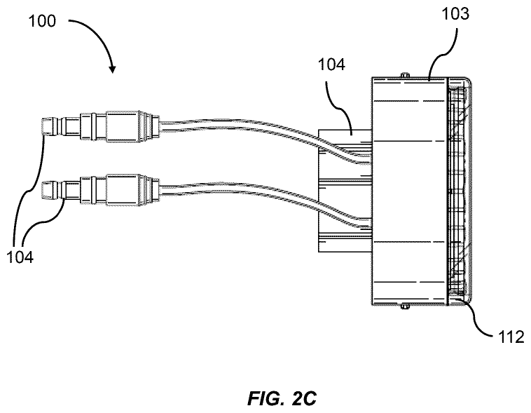

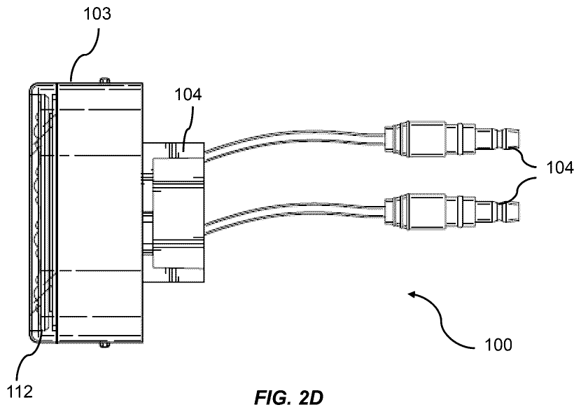

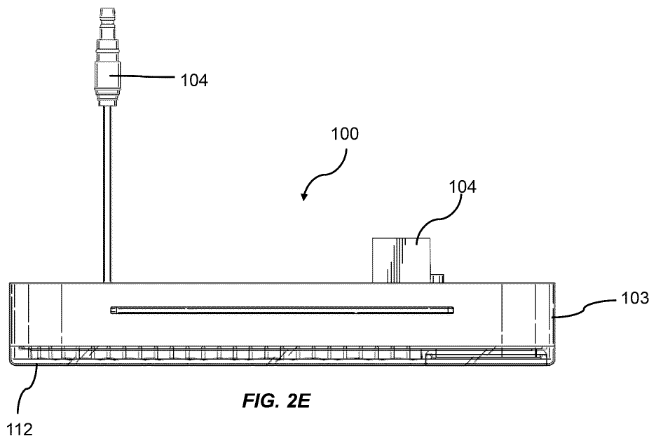

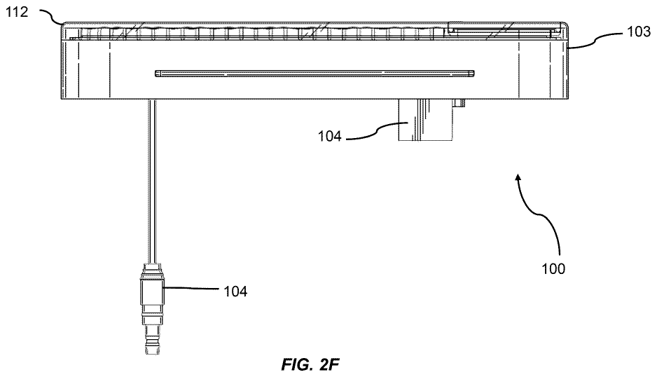

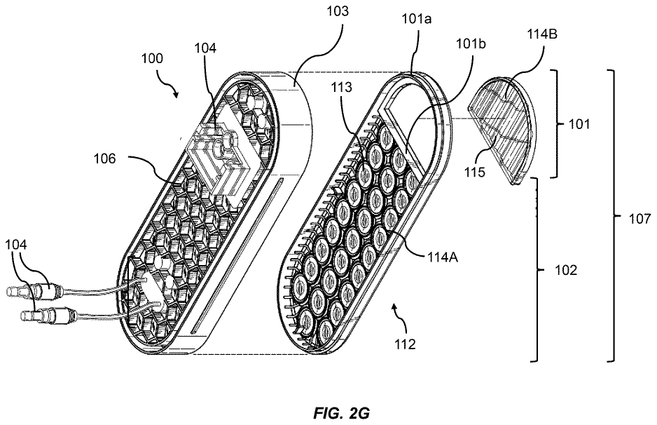

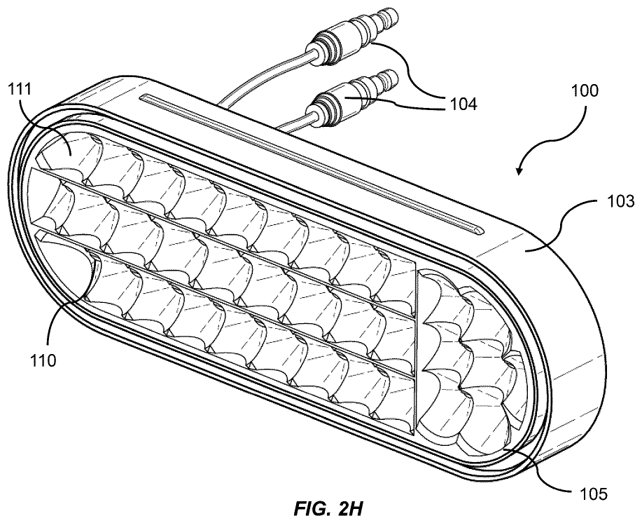

In some instances, the LEDs 110 of the LED lighting system 105 corresponding to the first section 102 may be positioned with respect to one another, as illustrated in FIG. 1A, to form concentric rings around an LED positioned in the center of the lighting surface 107. In other instances, as illustrated in FIG. 2A, the LEDs 110 of the LED lighting system 105 corresponding to the first section 102 are arranged in rows. It will be understood that other arrangements of the LEDs in the first section 102 may also be used.

The LEDs 110 of the LED lighting system 105 corresponding to the second section 101 may be arranged in a row, as illustrated in FIG. 1A. In some instances, the LEDs 110 of the LED lighting system 105 corresponding to the second section 101 may form more than one row, as illustrated in FIG. 2A. It will be understood that other arrangements of the LEDs in the second section 101 may also be used.

The lighting device 100 may include a lens 112 positioned over a face of the LED lighting system 105 revealing the LEDs 110 (such as the face visible in the front view of the lighting device 100 as illustrated in FIG. 1F). For the first section 102, a first lens portion 114A of the lens 112 may include a surface pattern or shape that corresponds or follows the pattern of the reflectors 111 of the LED lighting system 105 to influence the direction, polarization or other properties of the light transmitted through the first lens portion. For instance, the first lens portion 114A may include a well or dome structure 113 for each reflector 111 of the LED lighting system 105, where each well or dome structure 113 may align with the corresponding reflector 111 once the lens 112 is placed over the LED lighting system 105. The well or dome structure 113 may further influence the direction, polarization or other properties of light emitted by one or more LEDs 110 of the LED lighting system 105 (e.g. through refraction of the light) to provide a light distribution with desired characteristics. For the second section 101, a second lens portion 114B that corresponds with the second section 101 may include a surface pattern or shape to influence the direction, polarization or other properties of light transmitted through the second lens portion. For instance, as illustrated in FIG. 1F, the pattern of the second lens portion 114B may include linear striations 115 to provide a light distribution with desired characteristics. The second lens portion 114B corresponding to the second section 101 may be removable, received within a compartment defined within the lens 112 (e.g. for replacement from the rest of the lens 112) and therefore is interchangeable with other lens portions for the second section 101 for generating different light distributions from the second section 101.

The first section 102 of the lighting surface 107 may be configured to emit light at a first colour, while the second section 101 of the lighting surface 107 may be configured to emit light at a second colour. In one embodiment, the first colour may be red, and the second colour may be white. In another embodiment, the first colour may be yellow, and the second colour may be white. In another embodiment, the first colour may be orange, and the second colour may be yellow. It will be understood that different combinations of first and second colours may be provided without departing from the present teachings, and colour combinations between the first and second colours may be dictated by regulatory requirements in certain jurisdictions and/or functionality of the different sections of the lighting surface 107. For instance, the second section 101 may emit yellow light for operating as a fog light. In some embodiments, the colour of the light emitted by a section, such as the second section 101, may change, the light alternating between at least two colours (white and yellow), depending on the type of input received at the lighting device 100. For example, the light emitted at the first section 102 may alternate between red and orange depending on the type of input received at the lighting device 100 (e.g. the receipt of input that the driver has put the vehicle into “all terrain mode” may cause the light of the first section 102 to switch from red to orange, and the receipt of input that the driver has removed the “all terrain mode” of the vehicle resulted in the light emitted by the first section 102 switching back from orange to red).

In some instances, the first colour and second colour may be achieved by having LEDs of the LED lighting system 105 facing the corresponding first section 102 and second section 101 emit light in the given colour. In some instances, the first color and the second colour may be achieved by having the lens 112 or corresponding first section or second section of the lens 112 being provided in the necessary colour (e.g. such that when white light passes through the material of the given colour, light of that given colour is emitted).

In one example, as shown in FIGS. 1A to 1H when the lighting surface 107 has a circular shape, the lighting surface 107 may have a diameter of approximately 4 inches. However, it will be understood that the dimensions of the lighting surface 107 may vary without departing from the present teachings.

The second section 101 is located in a concentrated area on the lighting surface 107. The second section 101 may be an uninterrupted area of the lighting surface 107 that is adjacent to the first section 102 such that the light produced by the second section 101 is concentrated.

In some instances, the second section 101 may have a first portion 101a of its parameter that is adjacent to a portion of the edge of the lighting surface 107, where the first portion 101a has a shape that follows the shape of the portion of the edge of the lighting surface 107. A second portion 101b of the perimeter of the second section 101 may interconnect a first end of the first edge 101a and a second end of the first edge 101a thereby defining a boundary line passing through the lighting surface 107. The second portion 101b defining the boundary line may be straight, curved or have a combination of one or more straight sections or one or more curved sections.

In some embodiments, as shown in FIG. 1A, the second section 101 may have the shape of a segment or portion of a circle (e.g. when the lighting surface 107 has a circular shape, the second section 101 being a minor segment of the circle). However, it will be understood that the second section 101 may take another shape (e.g. a circular shape, an oval shape, rectangular shape, etc.) and/or positioned elsewhere on the lighting surface 107 at a concentrated area without departing from the present teachings.

The first section 102 shares an edge with the second section 101 (second edge 101b) along the boundary line. In some instances, the first section 102 may take up the remainder of the lighting surface 107 (e.g. being a major segment when the lighting surface 107 has a circular shape) or may encompass some or all of the periphery of second section 101.

In some instances (not shown), there may be additional second sections 101 in concentrated areas of the lighting surface 107 that can each operate as a work light. For example, when the lighting surface 107 has an ellipsoid shape, such as shown in FIG. 2A, a second section 101 may be found at one end of the ellipsoid shape of the lighting surface 107 and a further second section 101 may be found at the opposite end of the ellipsoid shape of the lighting surface 107.

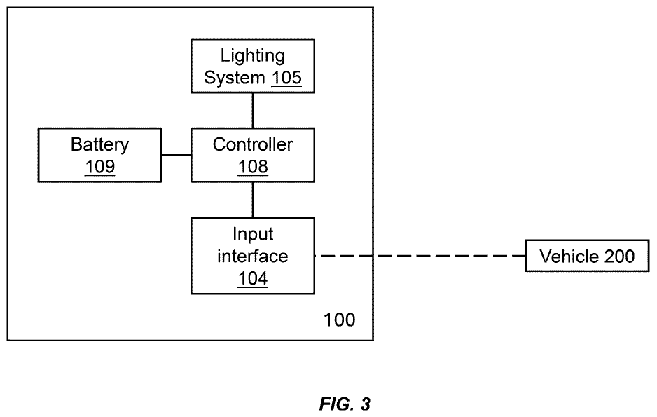

The lighting device 100 may include a controller 108. As illustrated in FIG. 3, the controller 108 may be configured to receive inputs from the vehicle 200 through the input interface 104, and cause the LED lighting system 105 to generate a lighting effect (e.g. turn on or turn off the LEDs 110 corresponding to the first section 102 or to the second section 101 or increase or decrease the luminosity of the light generated by the LEDs 110 corresponding to the first section 102 or to the second section 101). The controller 108 may be circuitry, a control board (a switchboard), a microprocessor, a processor combined with non-transitory memory, etc.

The input interface 104 enables exchange between the lighting device 100 and the vehicle 200 or an external device. In some embodiments, the input interface 104 receives input from the vehicle 200 (e.g. a state of the vehicle such as an operating state, a moving state, a braking state, a turning state, a reversing state, etc.) or input from other external device configured to generate a lighting effect by the LED lighting system 105, can transmit input to the vehicle 200 or other device from the lighting device 100 or can receive power from the vehicle 200 or other power source. The input interface 104 may be or include wiring, an adapter, a plug, male or female connectors, etc.

In some instances, as illustrated in the exemplary lighting device 100 of FIGS. 1A-1H, the lighting device 100 may include more than one input interface 104. As shown in FIG. 1B, the lighting device 100 may have a first input interface 104 that includes bullet plugs for connecting to the vehicle and, e.g., where the bullet plugs receive input on if the vehicle is in a reverse state (e.g. the vehicle is put into reverse) and/or receive input related to causing the second section 101 to function as a work light (such as a press of a power switch), and correspondingly receive power from the vehicle to cause the second section 101 to generate the intended lighting effect that corresponds to the input received. The lighting device 100 may also have a second input interface 104, e.g. a PL3 connector as shown in the example of FIG. 1B, for receiving input from the vehicle regarding a state of the vehicle (e.g. an operating state, a moving state, a braking state, a turning state, a reversing state, etc.) and for providing power to generate the corresponding lighting effect at the first section 102 corresponding to the input.

In some embodiments, when the input interface 104 is configured to relay all the necessary inputs and power to the relevant sections (first section 102 and second section 101) of the lighting device 100, the lighting device 100 may not include the controller 108, as the input interface 104 designated for a given section of the lighting device 100 and for a given input type relays power to the relevant section of the lighting device 100 to cause the appropriate lighting effect to be generated when the corresponding input action is taken at the vehicle. For instance, when the vehicle is in an operating state, a first input interface 104 relays power to LEDs related to the first section 102 to cause the LEDs to emit light at a lower luminosity level. When the vehicle is in a braking state or a turning state, a second input interface 104 relays power to LEDs related to the first section 102 to cause the LEDs to emit light at an upper luminosity level greater than the lower luminosity level. When the vehicle is in a reversing state, a third input interface 104 relays power to LEDs related to the second section 101 to cause the LEDs to emit light at a lower luminosity level. When a power switch is activated, a fourth input interface 104 relays power to LEDs related to the second section 101 to cause the LEDs to emit light at an upper luminosity level greater than the lower luminosity level, thereby functioning as a work light or other functionality (for example a fog light).

In some instances, the lighting device 100 includes a battery 109 for supplying power to the lighting device 100. The battery 109 may be rechargeable and may receive power from the vehicle 200 via the input interface 104 or another connector. In some instances, the lighting device 100 does not include a battery 109, instead receiving power directly from the electrical system of the vehicle 200.

The housing 103 contains and may protect different components of the lighting device 100, such as the LED lighting system 105, the controller 108 and/or the battery 109. The housing 103 may have a shape that matches the shape of the lighting surface 107 (e.g. a circular shape). The sides of the housing 103 may be adapted for insertion into a cavity on the vehicle 200, where the housing 103 may have a tight fit with the cavity on the vehicle 200 for receiving the housing 103 (e.g. where a fastener or sealer may be used to secure the housing 103 into the cavity of the vehicle). For example, the housing 103 may be adapted to be used with a grommet mount or may be provided with a flange extending around some or all of the periphery adapted to engage with a fastener (for example screws) to secure the housing into the cavity of the vehicle. The housing 103 may be made from plastic, from metal, or other suitable material.

In some instances, the lighting device 100 includes the heat sink 106 for dissipating heat generated by one or more of the LEDs 110 configured to emit light from the second section 101 and, in some instances, to dissipate the heat generated by the LEDs 110 configured to emit light from the first section 102. The heat sink 106 may be positioned at a rear of the housing 103 of the lighting device 100, as shown in FIG. 1G. In the example shown in FIG. 1G, the heat sink 106 is a honeycomb or lattice structure for dispersing the heat. However, it will be understood that the heat sink 106 may take another form for dispersing heat, such as a series of fins connected to the back of the housing 103, without departing from the present teachings.

The controller 108 may configured to receive input via the input interface 104 (e.g. from the vehicle 200 or in some instances, from another input device), and cause a lighting effect that corresponds to the nature of the input that is received. Alternatively, the controller 108 may be positioned outside the lighting device 100 and be configured to be connected to input interface 104 and to receive inputs from the vehicle or other input device and cause a lighting effect that corresponds to the nature of the input using the input interface 104.

The controller 108 may causes the LEDs 110 of the LED lighting system 105 corresponding to the first section 102 to turn on when a first input is received from the vehicle 200. The controller 108 may cause the LEDs 110 of the LED lighting system 105 corresponding to the first section 102 to turn off when the first input is no longer received, or when a new input is received. The first input may be continuous over a period of time. In some instances, the first input is indicating an operating state, thereby causing the LEDs of the LED lighting system 105 corresponding to the first section 102 to turn emit light. In some embodiments, the first input may be indicating one or more of an operating state, a moving state, a braking state, a turning state or a reversing state of the vehicle 200.

In some embodiments, the controller 108 may cause the LEDs 110 of the LED lighting system 105 corresponding to the first section 102 to emit light at two luminosity levels. Light is emitted at a lower luminosity level upon receipt of a first input to indicate an operating state, and light is emitted at an upper luminosity level greater than the lower luminosity level upon receipt of a further input when the vehicle is in one or more of a moving state, a braking state, a turning state or a reversing state.

The controller 108 many cause the LEDs 110 of the LED lighting system 105 corresponding to the second section 101 to turn on at a lower luminosity level, when a second input is received from the vehicle 200. The controller 108 may cause the LEDs of the LED lighting system 105 corresponding to the second section 101 to turn off, when the second input is no longer received or when a new input is received (e.g. when a third input is received to increase the luminosity level produced by the LEDs of the LED lighting system 105 to an upper luminosity level that is greater than the lower luminosity level). The second input may be continuous, received over a period of time. In some embodiments, the second input is a signal received from the vehicle 200 corresponding to the vehicle 200 being in a reversing state.

The controller 108 may further cause the LEDs 110 of the LED lighting system 105 corresponding to the second section 101 to turn on at an upper luminosity that is greater than the lower luminosity, when a third input is received from the vehicle 200 or other input device (e.g. a switch). In some embodiment, the LEDs of the LED lighting system 105 corresponding to the second section 101 may already be turned on at the lower luminosity, where the receipt of the third input by the controller 108 may cause the LEDs of the LED lighting system 105 corresponding to the second section 101 to increase luminosity from the lower luminosity level to the upper luminosity level. In some instances, the controller 108 may cause the LEDs of the LED lighting system 105 corresponding to the second section 101 to turn off when the third input is no longer received, or when a subsequent input is received by the controller 108 or other input device. In some embodiments, the controller 108 may cause the LEDs 110 of the LED lighting system 105 corresponding to the second section 101 to reduce a luminosity level from the upper luminosity level back to the lower luminosity level following receipt of the subsequent input. In some embodiments, the third input may correspond to input provided by a power switch used by the operator. In some instances, the subsequent input received to turn off or reduce the luminosity level of the LEDs of the LED lighting system 105 corresponding to the second section 101 providing light at the upper luminosity level may also be provided by a power switch. In some instances, the power switch may be configured by the user (e.g. the input type received to turn on the power switch may be configured by the user).

In some embodiments, the controller 108 may upon receipt of a further input cause the LEDs 110 of the LED lighting system 105 corresponding to the second section 101 emit light at a luminosity level that is greater than each of the luminosity levels of the light produced at the first section 102. In other embodiments, the controller 108 may be configured to prevent light being produced in the second section 101 at the upper luminosity level during certain states of the vehicle 200 (e.g. light cannot be produced in the second section 101 at the upper luminosity level when the vehicle is in a moving state).

It will be understood that, in some embodiments, the controller 108 may be configured, and the LEDs of the LED lighting system 105 corresponding to the second section 101 may be adapted to, provide for more than two luminosity levels, where a shift between luminosity levels is performed in accordance with types of input received at the controller 108.

When the LED lighting system 105 is changing between luminosity levels for a given section of the LED lighting system 105 (i.e. an increase in luminosity level or a decrease in luminosity level), exemplary implementations for performing this change in luminosity level may be achieved using the same LEDs of the LED lighting system 105 and/or by having the additional LEDs of the LED lighting system 105 of the given section turn on or off depending on the intended luminosity level for that section of the LED lighting system 105.

In some instances, the multiple inputs may arise as a result of a single vehicle state (e.g. the brakes of the vehicle being applied causes the LEDs of the LED lighting system 105 corresponding to the first section 102 to switch from the lower intensity level to the upper intensity level on as well as cause the LEDs of the LED lighting system 105 corresponding to the second section 101 to turn on at the upper luminosity level).

In some embodiments, the controller 108 may receive input from another source aside from the vehicle 200 (e.g. through the input interface 104 or through another input/output interface, such as a transceiver). For instance, in some instances, the controller 108 may receive input from a portable computing device (e.g. a smartphone, smartwatch, tablet, etc.) that communicates with the controller 108 through an I/O interface, where the portable computing device may be running a client application program for providing input to the controller 108 (e.g. to cause the LEDs 110 of the LED lighting system 105 corresponding to the second section 101 to generate light at the upper luminosity). In some instances, the lighting device 100 may include an input device (e.g. a button), for causing an operator to provide input that causes the generating of a lighting effect via the controller 108 (such as to cause the LEDs of the LED lighting system 105 corresponding to the second section 101 to generate light at the upper luminosity) when input is received at the input device.

As such, the lighting device 100 is configured to alternate between different lighting modes, to provide multiple functionalities for vehicle operators. The lighting device 100 generates a signal for other vehicles regarding a variety of states of the vehicle (e.g. an operating state, a moving state, a braking state, a turning state, a reversing state, etc.) and can also function as a work light following receipt of given input (e.g. to assist illuminating an area adjacent to the lighting device when light levels are low, for example at night).

FIGS. 2A-2H illustrate a further exemplary lighting device 100 in accordance with the present teachings wherein corresponding elements to those set out above with respect to FIGS. 1A-1H have the same numbering. In this embodiment, the lighting device 100 has an ellipsoid shape and the second section 101 is positioned at one end thereof. It will be understood that the second section 101 could alternately be positioned at other locations on the lighting surface 107. For example, the second section 101 could be in the shape of a segment of a circle and positioned in the middle along the lower straight edge of the lighting surface 107 such that the straight edge of the second section 101 is adjacent to a portion of the lower straight edge of the lighting surface 107.

### Exemplary Method of Operating a Lighting Device Configured to Signal Other Vehicles and to Function as a Worklight

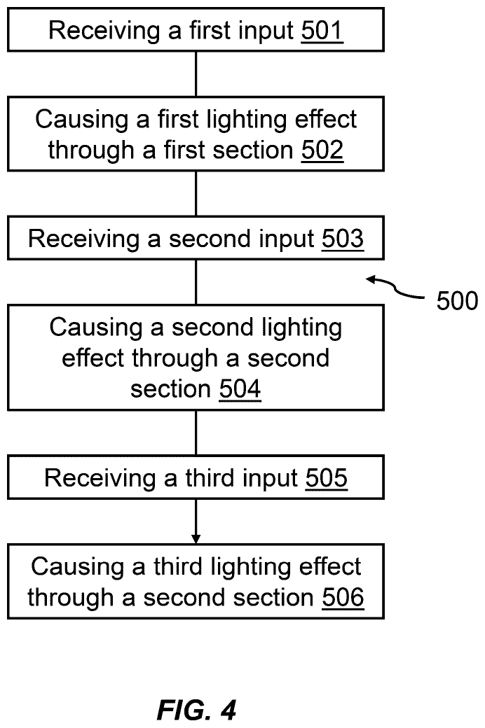

Reference is now made to FIG. 4, illustrating an exemplary method 500 of operating a lighting device that is configured to send out a signal to drivers of other vehicles and to function as a work light. The method 500 may be performed with lighting device 100. However, it will be understood that method 500 may be performed using any other lighting device in accordance with the present teachings.

The lighting device is connected to the vehicle in order to receive input from the vehicle (e.g. through a wired connection).

A first input is received at step 501 corresponding to a state of the vehicle resulting from an action performed by the driver. For instance, the first input may be the vehicle being in an operating state. In other instances, the first state may correspond to a moving state, a braking state, a turning state or a reversing state. It will be understood that more than one type of first inputs may be received at step 501.

Upon receiving the first input at step 501, a first lighting effect is generated in a first colour in a first section of a lighting surface of the lighting device at step 502. For instance, the first section may be adapted to produce a red colour. In some embodiments, the light produced at the first section may be intermittent (e.g. when the first lighting effect corresponds to a turning state).

The lighting device may stop generating the first lighting effect when the first input is no longer received (when the first input is received over a period of time, and that input stops, such as when the first lighting effect is maintained as long as the vehicle is braking). In some instances, the first lighting effect ceases when further input is received at the lighting device.

In some instances, the first section may produce a lighting effect in a first colour and at a lower luminosity level when a first input is received (e.g. when the vehicle is in an operating state), and the first section may produce a lighting effect in the first colour at an upper luminosity level greater than the lower luminosity level when a further input is received (e.g. the vehicle is in a braking state, or a turning state).

A second input may be received at step 503. The second input may be, for instance, resulting from the vehicle being in a reversing state.

Upon receiving the second input, a second lighting effect is generated, produced by a second section of the lighting surface of the lighting device at step 504. The second lighting effect may be producing a white light at a lower luminosity (e.g. above 200 lumens; at 300 lumens, etc.). The second section may occupy a smaller portion of the lighting surface than the first section. The second lighting effect may be of a different colour than the first lighting effect. For example, the second lighting effect may be white in colour.

The lighting device may stop generating the second lighting effect when the second input is no longer received (when the second input is received over a period of time, and that input subsequently stops, such as when the second lighting effect is maintained as long as the vehicle is in reverse). In some instances, the second lighting effect ceases when further input is received at the lighting device.

A third input is received at step 505. In some instances, the third input may be received from the vehicle such as from a vehicle power switch. In some instances, the third input may be received from an external device, such as an external switch or other input device provided on or with the lighting device, a portable computing device in communication with the lighting device, etc.

The receipt of the third input causes a generation of a third lighting effect at the second section of the lighting surface of the lighting device at step 506 (e.g. in a same colour as the second lighting effect of step 504). The third lighting effect is generated at an upper luminosity level that is greater than the lower luminosity level of the second lighting effect at step 504. For instance, in some instances, the luminosity level of the second lighting effect may be equal to or greater than 800 lumens. As such, at step 506, the lighting device may function as a work light, producing light for an area adjacent to lighting device to perform tasks in the dark or in low light conditions.

The lighting device may stop generating the third lighting effect when the third input is no longer received (when the third input is received over a period of time, and that input stops, such as when the third lighting effect is maintained as long as the power switch is on). In some instances, the third lighting effect ceases when further input is received at the lighting device.

It will be understood that different combinations of steps 501 to 506 may be provided, depending on the input types received at the lighting device (e.g. depending on the actions performed by the driver of the vehicle).

It will be understood that, in some scenarios, the first section of the lighting surface and the second section of the lighting surface may be producing light simultaneously (depending on the input received at the lighting device).

Although the invention has been described with reference to preferred embodiments, it is to be understood that modifications may be resorted to as will be apparent to those skilled in the art. Such modifications and variations are to be considered within the purview and scope of the present invention.

Representative, non-limiting examples of the present invention were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

1. A lighting device adapted for fastening to a vehicle, comprising:
a housing;
an LED lighting system contained at least partially within the housing defining a lighting surface for generating light, wherein the lighting surface includes a first section and a second section in a concentrated area adjacent to the first section, the LED lighting system comprising:
a first LED array adapted to emit light from the first section; and
a second LED array adapted to emit light from the second section at a lower luminosity level and an upper luminosity level, wherein the upper luminosity level is greater than the lower luminosity level; and
an input interface adapted to receive inputs to selectivity cause:
an emission of light from the first LED array to signal a first state of the vehicle;
an emission of light at the lower luminosity level from the second LED array to signal a second state of the vehicle; and
an emission of light at the upper luminosity level from the second LED array.

2. The lighting device according to claim 1, further comprising a heat sink adapted to dissipate heat generated by at least the second LED array.

3. The lighting device according to claim 2, wherein the heat sink is positioned on a back surface of the housing.

4. The lighting device according to claim 1, wherein:
the first state of the vehicle is any one of an operating state, a moving state, a braking state, a turning state, and a reversing state; and
the second state of the vehicle is any one of an operating state, a moving state, a braking state, a turning state, and a reversing state that is different from the first state; and
the upper luminosity level of the second LED array is to provide a work lamp function.

5. The lighting device according to claim 1, wherein
the first LED array is adapted to emit light at a lower luminosity level and an upper luminosity level, wherein the upper luminosity level is greater than the lower luminosity level; and
the input interface is adapted to receive inputs to selectively cause:
an emission of light at the lower luminosity level from the first LED array to signal the first state of the vehicle; and
an emission of light at the upper luminosity level from the first LED array to signal a third state of the vehicle.

6. The lighting device according to claim 5, wherein:
the first state of the vehicle is an operating state or a moving state; and
the third state of the vehicle is either a braking state or a turning state.

7. The lighting device according to claim 6, wherein:
the third state of the vehicle is a turning state; and
light is emitted at the upper luminosity level from the first LED array intermittently.

8. The lighting device according to claim 1, wherein the light emitted from the first section is a first colour and the light emitted from the second section is a second colour different from the first colour.

9. The lighting device according to claim 8, wherein the first colour is red and the second colour is white.

10. The lighting device according to claim 1, further comprising a controller that is configured to receive the inputs to selectively cause:
an emission of light from the first LED array to signal the first state of the vehicle;
an emission of light at the lower luminosity level from the second LED array to signal the second state of the vehicle; and
an emission of light at the upper luminosity level from the second LED array.

11. The lighting device according to claim 5, further comprising a controller that is configured to receive the inputs to selectively cause:
an emission of light at the lower luminosity level from the first LED array to signal the first state of the vehicle;
an emission of light at the upper luminosity level from the first LED array to signal the third state of the vehicle;
an emission of light at the lower luminosity level from the second LED array to signal the second state of the vehicle; and
an emission of light at the upper luminosity level from the second LED array.

12. The lighting device according to claim 10, wherein the controller comprises an electrical circuit.

13. The lighting device according to claim 10, wherein the controller comprises a microprocessor.

14. The lighting device according to claim 1, wherein the second section of the LED lighting system is defined between a portion of an edge of the lighting surface and a boundary line that runs from a first point of the edge to a second point of the edge, the boundary line separating the first section of the LED lighting system from the second section of the LED lighting system.

15. The lighting device according to claim 1, wherein the upper luminosity level of the second LED array is equal to or greater than 800 lumens.

16. The lighting device according to claim 1, wherein the input interface receives power from the vehicle for powering the LED lighting system.

17. The lighting device according to claim 1, further comprising a battery for supplying power to the LED lighting system.

18. The lighting device according to claim 1, wherein the vehicle is a truck and the lighting device is adapted to be fastened to a rear of the truck.

19. The lighting device according to claim 1, wherein the vehicle comprises a trailer and the lighting device is adapted to be fastened to a rear of the trailer.

20. A vehicle comprising the lighting device according to claim 1, wherein the lighting device is fastened to a rear of the vehicle.
